(19) United States
(12) Patent Application Publication
(10) Pub. No.: US 2024/0097367 A1
(43) Pub. Date: Mar. 21, 2024

(54) ELASTIC CONNECTION STRUCTURE

(71) Applicant: PROSE TECHNOLOGIES (SUZHOU) CO., LTD., Suzhou (CN)

(72) Inventors: Congbin LIU, Beijing (CN); Xiaofeng HU, Beijing (CN)

(21) Appl. No.: 18/275,705

(22) PCT Filed: Jul. 6, 2021
(86) PCT No.: PCT/CN2021/104619

§ 371 Date: Aug. 3, 2023

(30) Foreign Application Priority Data
Feb. 9, 2021 (CN) 202110180653.2

(51) Int. Cl. H01R 12/73; H01R 13/24

(52) U.S. Cl. CPC H01R 12/737; H01R 13/2414; H01R 13/2435

(57) ABSTRACT

The present disclosure discloses an elastic connection structure, which includes: a pair of mount members respectively electrically connected to a first circuit board, at least one first contact member in elastic connection to one mount member of the pair of mount members and electrically connected to one side of the second circuit board, and at least one second contact member in elastic connection to the other mounting member of the pair of mount members and electrically connected to the other side of the second circuit board. The second circuit board is clamped between the first contact member and the second contact member, such that the first circuit board is electrically connected to the second circuit board via the elastic connection structure.

### FIELD OF THE TECHNOLOGY

The present disclosure relates to a field of circuit board designs, and more particularly, to an elastic connection structure.

### BACKGROUND

PCB board (Printed Circuit Board), a Chinese name of which is printed circuit board, referred to as printed board, is one of the important components in the electronics industry. It is used to replace the chassis used to install electronic components and realize interconnection between electronic components. Since this type of board is produced using electronic printing, it is called a “printed” circuit board.”

With the development of science and technology, circuit integration of electronic products is enhanced in integration extent, modularization is getting more frequent. In many types of integrated drive and control products, there are usually several PCB boards connected together, and board-to-board connectors are often desirable.

Certain existing connection technology between PCB boards, for example, connection method for vertical connection between PCB boards to transmit signals generally resort to soldering or connectors for connection. In situations where solder is used for welding connection, the connector tolerance is small, assembly is difficult, and in actual use, there are defects such as difficulty in disassembly, pollution of the environment, and high manufacturing cost.

### SUMMARY

For the problems referred to above, the present disclosure in a first aspect provides an elastic connection structure, which includes: a pair of mount members, respectively electrically connected to a first circuit board; at least one contact member, configured to be in elastic connection to one of the pair of mount members and be electrically connected to one side of a second circuit board; and at least one second contact member, configured to be in elastic connection to the other of the pair of mount members and to be electrically connected to another side of the second circuit board, where, the second circuit board is clamped between the first contact member and the second contact member, such that the first circuit board is electrically connected to the second circuit board through the elastic connection structure.

In one embodiment, the elastic connection structure further includes a limit member, configured to be in elastic connection to the first contact member and the second contact member, such that one end of the second circuit board is positioned therein.

In one embodiment, the first contact member includes one or more first protrusions, each of the first protrusions is configured to be in electrical connection to the one side of the second circuit board.

In one embodiment, the second contact member includes one or more second protrusions, each of the second protrusions is configured to be in electrical connection to the another side of the second circuit board.

In one embodiment, a number of the first protrusions of the first contact member is same to or different than a number of the second protrusions of the second contact member.

In one embodiment, the first protrusions and the second protrusions are of symmetrical or asymmetrical shape.

In one embodiment, the limit member includes a first limit sub-member, configured to limit movement of the second circuit board along a vertical direction.

In one embodiment, the first circuit board is provided with a mount hole, such that the pair of mount members are fixed outside of the mount hole, where the first contact member, the second contact member, and the limit member are arranged inside of the mount hole; where, the limit member further comprises a second limit sub-member, the second limit sub-member contacts an inner wall of the mount hole, and is configured to limit movement of the second circuit board along a horizontal direction.

In one embodiment, the first circuit board includes a connect part, so that the pair of mount members are fixed on the connect part, and the first contact member, the second contact member, and the limit member are arranged above the connect part.

In one embodiment, when the elastic connection structure includes a plurality of first contact members and a plurality of second contact members, the plurality of the first contact members are arranged at intervals and in elastic connection to one of the pair of mount members, and the plurality of second contact members are arranged at intervals and in elastic connection to another of the pair of mount members.

In one embodiment, the first contact member is in elastic connection to the corresponding mount member to form a first slope, and the second contact member is in elastic connection to the corresponding mount member to form a second slope, and the first slope and the corresponding second slope form a guide member.

In a second aspect, the present disclosure provides an elastic connection structure, which includes: a mount member, electrically connected to a first circuit board; and at least one contact member, configured to be in elastic connection to the mount member and be electrically connected to one side of a second circuit board, where the first circuit board is electrically connected to the second circuit board through the elastic connection structure.

In one embodiment, the contact member includes one or more protrusions, each of the protrusions is configured to be in electrical connection to the one side of the second circuit board.

In one embodiment, the elastic connection structure further includes a block member, configured to limit movement of the second circuit board, and hence to keep electrical connection between the second circuit board and the contact member.

In one embodiment, the first circuit board is provided with a mount hole, such that the mount member is fixed outside of the mount hole and the contact member is positioned inside of the mount hole, and wherein an inner wall of the mount hole is the block member to keep electrical connection between the second circuit board and the contact member.

In one embodiment, the first circuit board includes a connect part, so that the mount member is electrically connected to the connect part, the block member and the mount member are positioned on the connect part, and wherein the contact member is positioned above the connect part.

In one embodiment, when the elastic connection structure includes a plurality of contact members, the plurality of contact members are arranged at intervals and in elastic connection to the mount member.

According to the elastic connection structure of the present disclosure, effective electrical connection between different circuit boards may be realized, and due to its structural design, the elastic connection structure disclosed in the present disclosure, when in actual implementation and in comparison to existing technologies, is of simple structure, small size, easy disassembly of the circuit board, large tolerance, and reduced manufacturing cost.

### BRIEF DESCRIPTION OF THE DRAWINGS

The features, advantages and other aspects of the various embodiments of the present disclosure will become more apparent with reference to the following detailed description when taken in conjunction with the accompanying drawings, which show several embodiments of the present disclosure by way of illustration and not limitation. In the attached drawings:

FIG. 1A is a schematic diagram of a first exemplary elastic connection structure according to the present disclosure;

FIG. 1B is an exploded schematic view of the first embodiment of the elastic connection structure according to the present disclosure;

FIG. 1C is a schematic diagram showing an overall connection of the first embodiment of the elastic connection structure according to the present disclosure;

FIG. 2A is a schematic diagram of a second exemplary elastic connection structure according to the present disclosure;

FIG. 2B is an exploded schematic view of an elastic connection structure according to the second embodiment of the present disclosure;

FIG. 2C is a schematic view showing an overall connection of the elastic connection structure according to the second embodiment of the present disclosure;

FIG. 3A is a schematic diagram of a third exemplary elastic connection structure according to the present disclosure;

FIG. 3B is an exploded schematic view of an elastic connection structure according to the third embodiment of the present disclosure;

FIG. 3C is a schematic view showing an overall connection of the elastic connection structure according to the third embodiment of the present disclosure;

FIG. 4A is a schematic diagram of a fourth elastic connection structure according to the present disclosure;

FIG. 4B is an exploded schematic view of an elastic connection structure according to the fourth embodiment of the present disclosure;

FIG. 4C is a schematic view showing an overall connection of the elastic connection structure according to the fourth embodiment of the present disclosure;

FIG. 5A is a schematic diagram of a fifth exemplary elastic connection structure according to the present disclosure;

FIG. 5B is an exploded schematic view of an elastic connection structure according to the fifth embodiment of the present disclosure;

FIG. 5C is a schematic view showing an overall connection of the elastic connection structure according to the fifth embodiment of the present disclosure;

FIG. 6A is a schematic diagram of a sixth exemplary elastic connection structure according to the present disclosure;

FIG. 6B is an exploded schematic view of an elastic connection structure according to the sixth embodiment of the present disclosure;

FIG. 6C is a schematic view showing an overall connection of an elastic connection structure according to the sixth embodiment of the present disclosure;

FIG. 7A is a schematic diagram of a seventh exemplary elastic connection structure according to the present disclosure;

FIG. 7B is an exploded schematic view of an elastic connection structure according to the seventh embodiment of the present disclosure;

FIG. 7C is a schematic view showing an overall connection of an elastic connection structure according to the seventh embodiment of the present disclosure;

FIG. 8A is a schematic diagram of an eighth exemplary elastic connection structure according to the present disclosure;

FIG. 8B is an exploded schematic view of an elastic connection structure according to the eighth embodiment of the present disclosure;

FIG. 8C is a schematic view showing an overall connection of an elastic connection structure according to the eighth embodiment of the present disclosure;

FIG. 9 is a schematic diagram of a ninth exemplary elastic connection structure according to the present disclosure; and

FIG. 10 is a schematic diagram of a tenth exemplary elastic connection structure according to the present disclosure.

### DETAILED DESCRIPTION

The technical solutions of the present disclosure will be further described below through embodiments and in conjunction with the accompanying drawings. In the present disclosure, the same or similar reference numerals designate the same or similar components. The following description of the embodiments of the present disclosure with reference to the accompanying drawings is intended to explain the general inventive concept of the present disclosure, and should not be construed as a limitation of the present disclosure.

The terms “including”, “comprising”, and similar terms used herein should be understood as open terms, that is, “including/including but not limited to”, which means that other content may also be included. The term “based on” is “based at least in part on”. The term “one embodiment” means “at least one embodiment”; the term “another embodiment” means “at least one further embodiment”, and so on.

The embodiments of the present disclosure mainly focus on the following technical issues: how to improve the ease of disassembly of the connection structure, reduce its manufacturing cost and simplify the connection structure while ensuring effective electrical connection of multiple circuit boards.

In order to solve the above problems, the spring-type connection structure disclosed herein includes: a pair of mount members electrically connected to a first circuit board respectively, at least one first contact member in elastic connection to one of the pair of mount members, and at least one second contact member elastically connected to the other mount member of the pair of mount members; where, the first contact member is used for electrical connection to one side of a second circuit board, and the second contact member is used for electrical connection to the other side of the second circuit board, such that the second circuit board is clamped between the first contact member and the second contact member, and accordingly the first circuit board becomes electrically connected to the second circuit board via the elastic connection structure. In addition, the present disclosure provides another elastic connection structure, which includes: a mount member electrically connected to the first circuit board and at least one contact member electrically connected to the mount member; the contact member is used to electrically connect to one side of the circuit board, and the first circuit board is electrically connected to the second circuit board through the elastic connection structure.

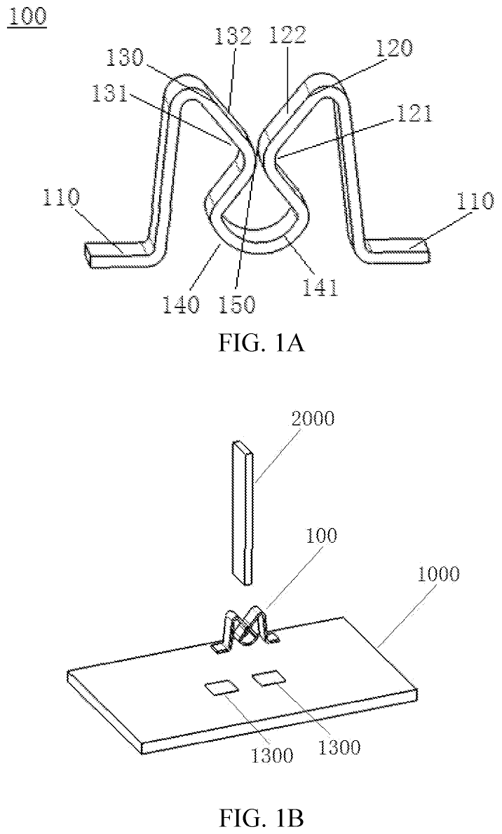

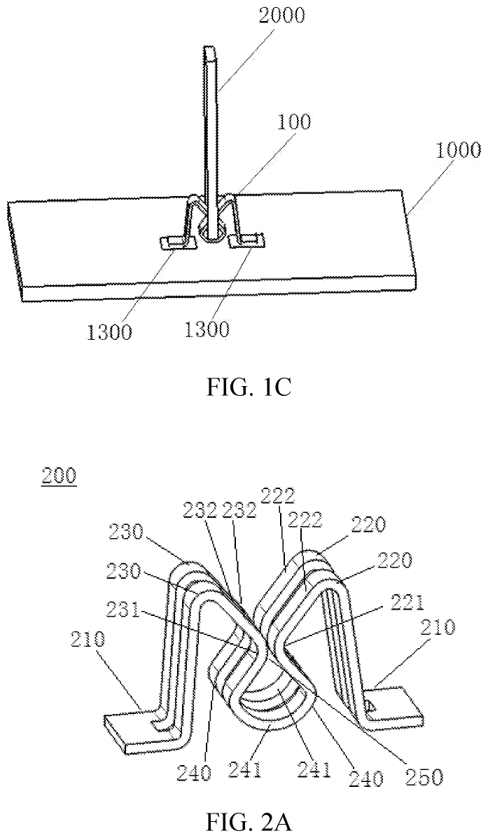

The following is a detailed description of the elastic connection structure disclosed in the present disclosure according to the accompanying drawings FIG. 1A to FIG. 10 and related embodiments.

### Embodiment One

As shown in FIG. 1A, this embodiment discloses an elastic connection structure 100, which includes: a pair of mount members 110, a first contact member 120, a second contact member 130, and a limit member 140, where, the first contact member 120 and the second contact member 130 are respectively in elastic connection to the corresponding mount member 110, and the limit member 140 is in elastic connection to a lower member of the first contact member 120 and a lower member of the second contact member 130.

In addition, in this embodiment, the first contact member 120 includes a first protrusion 121, and the second contact member 130 includes a second protrusion 131. As shown in FIG. 1A, in this embodiment, the shape of the first protrusion 121 is symmetrical to that of the second protrusion 131. The limit member 140 includes a first limit sub-member 141 for limiting a movement of the second circuit board in or along a vertical direction.

In addition, in this embodiment, the first circuit board 1000 includes a connect part 1300, such that the pair of mount members 110 of the elastic connection structure 100 are fixed onto the connect part 1300, and the first contact member 120, the second contact member 130, and the limit member 140 are arranged or positioned above the connect part 1300.

In this embodiment, the connect part 1300 may be in the form of a solder pad or weld pad designed on the first circuit board 1000.

As shown in FIG. 1B and FIG. 1C, in this embodiment, the pair of mount members 110 are respectively electrically connected to the first circuit board 1000 via the connect part 1300, such that the elastic connection structure 100 disclosed in this embodiment is firstly connected to the first circuit board 1000.

Subsequently, the second circuit board 2000 is inserted into the elastic connection structure 100, such that the first contact member 120 of the elastic connection structure 100 is electrically connected to one side of the second circuit board 2000, the second contact member 130 is connected to another side of the second circuit board, and one end of the second circuit board 2000 is disposed in the limit member 140. Specifically, a first protrusion 121 of the first contact member 120 is electrically connected to one side of the second circuit board 2000, and a second protrusion 131 of the second contact member 130 is electrically connected to the another side of the second circuit board 2000, and the one end of the second circuit board 2000 is disposed in a first limit sub-member 141.

When the first circuit board 1000 and the second circuit board 2000 are electrically connected through the disclosed elastic connection structure 100, communication in signals, voltages, currents, and the like may be realized between the first circuit board 1000 and the second circuit board 2000.

In addition, due to an existence of the first protrusion 121 in the first contact member 120, a slope or an inclined surface 122 is formed after the first contact member 120 is in elastic connection to the corresponding mount member 110; correspondingly, due to an existence of the second protrusion 131 of the second contact member 130, a slope or an inclined surface 132 is formed after the second contact member 130 in elastic connection to the corresponding mount member 110. Thus, the two slopes form a V-shaped guide member 150, which, during the process of an insertion of the second circuit board 2000 into the elastic connection structure 100, guides an insertion of the second circuit board 2000 and allows a presence of a relatively larger tolerance on both sides of the second circuit board 2000.

In this embodiment, PCB boards may be used as the first circuit board 1000 and the second circuit board 2000.

In addition, another elastic connection structure 3000 shown in FIG. 10 has an overall structure similar to the structure of the elastic connection structure 100 shown in FIGS. 1A-1C, for example, including a pair of mount members 3100, a first contact member 3200, a second contact member 3300, and a limit member 3400, where, the first contact member 3200 and the second contact member 3300 are electrically connected to the corresponding mount member 3100 respectively, and the limit member 3400 is electrically connected to a lower member of the first contact member 3200 and a lower member of the second contact member 3300. In the elastic connection structure 3000 shown in FIG. 10, the first contact member 3200 includes a first protrusion 3210, and the second contact member 3300 includes a plurality of second protrusions (for example, the second protrusion 3310, the second protrusion 3320), that is, the elastic connection structure 3000 includes a different number of first protrusions 3210 and second protrusions. In addition, it is seen from FIG. 10 that the shape of the first protrusion 3210 is asymmetrical to the shapes of the plurality of second protrusions, such that the elastic connection structure 3000 may realize a single-point electrical connection between one side thereof and the second circuit board, and a multi-point electrical connection between another side thereof and the second circuit board, to meet requirements of different types of second circuit boards (for example, the number of signal contacts included on both sides is different).

### Embodiment Two

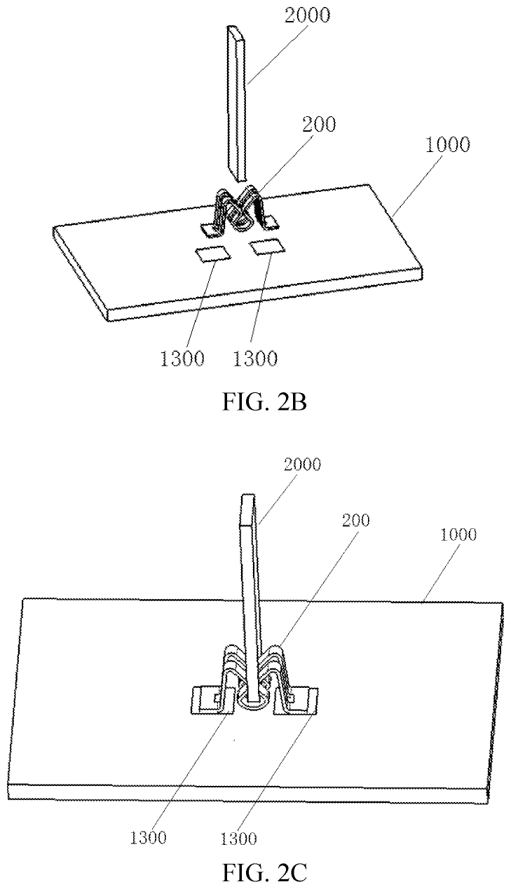

As shown in FIG. 2A, this embodiment provides an elastic connection structure 200, which includes: a pair of mount members 210, a plurality of first contact members 220, a plurality of second contact members 230, and a plurality of limit member 240. Where, the plurality of first contact members 220 are arranged at intervals and are in elastic connection to corresponding mount member 210, and the plurality of second contact members 230 are arranged at intervals and are in elastic connection to corresponding mount member 210, each limit member 240 is in elastic connection to a lower member of the corresponding first contact member 220 and a lower member of the corresponding second contact member 230.

In addition, in this embodiment, each first contact member 220 includes a first protrusion 221, and each second contact member 230 includes a second protrusion 231. In this embodiment, the shape of the first protrusion 221 is symmetrical to that of the second protrusion 231.

Moreover, in this embodiment, each limit member 240 specifically includes a first limit sub-member 241. In addition, the first circuit board 1000 is provided with a connect part 1300, such that the pair of mount members 210 of the elastic connection structure 200 is fixed on the connect part 1300, and a plurality of first contact members 220, a plurality of second contact members 230, and a plurality of limit members 240 are disposed above the connect part 1300.

In this embodiment, the connect part 1300 may be in the form of a solder pad or weld pad designed on the first circuit board 1000.

As shown in FIG. 2B and FIG. 2C, in this embodiment, the pair of mount members 210 are respectively electrically connected to the first circuit board 1000 via the connect parts 1300, such that the elastic connection structure 200 disclosed in this embodiment is first electrically connected to the first circuit board 1000.

Subsequently, the second circuit board 2000 is inserted into the elastic connection structure 200, such that the plurality of first contact members 220 of the elastic connection structure 200 are electrically connected to one side of the second circuit board 2000, the plurality of second contact members 230 are electrically connected to the other side of the second circuit board 2000, and one end of the second circuit board 2000 is disposed in the plurality of limit members 240. Specifically, each first protrusion 221 is electrically connected to one side of the second circuit board 2000, and each second protrusion 231 is electrically connected to the another side of the second circuit board 2000. When the second circuit board 2000 is inserted into the elastic connection structure 200, the plurality of first limit sub-members 241 may limit the movement of the second circuit board 2000 in the vertical direction, and may keep one end of the second circuit board 2000 in a plurality of first limit sub-members 241.

When the first circuit board 1000 and the second circuit board 2000 are in electrical connection through the disclosed elastic connection structure 200, transmission of signals, voltages, currents, and the like may be realized between the first circuit board 1000 and the second circuit board 2000.

In certain embodiment(s), due to the existence of the plurality of first protrusions 221, the plurality of first contact members 220 are in elastic connection to the corresponding mount member 210 to form a plurality of slopes 222. Correspondingly, due to the existence of the plurality of second protrusions 231, the plurality of second contact members 230 are in elastic connection to the corresponding mount member 210 to form a plurality of slopes 232; thus, the corresponding two slopes form a V-shaped guide member 250 which, when the second circuit board 2000 is inserted into the elastic connection structure 200, guides the insertion of the second circuit board 2000 and allows for relatively larger tolerances on both sides of the second circuit board 2000.

In this embodiment, the elastic connection structure 200 disclosed in this embodiment includes a same number of a plurality of first contact members 220 and a same number of a plurality of second contact members 230. Therefore, when the two sides of the second circuit board 2000 respectively include a plurality of signal contacts, the same number of first contact members 220 and second contact members 230 may be selected according to the number of signal contacts, to realize sufficient electrical connection between the second circuit board 2000 and the first circuit board 1000 via the elastic connection structure 200.

In this embodiment, each second contact member 230 may also adopt the structure of the second contact member 330 shown in FIG. 10, that is, each second contact member 230 may include a plurality of second protrusions, such that the elastic connection structure 200 may realize multi-point electrical connection to the second circuit board 2000 in different directions.

### Embodiment Three

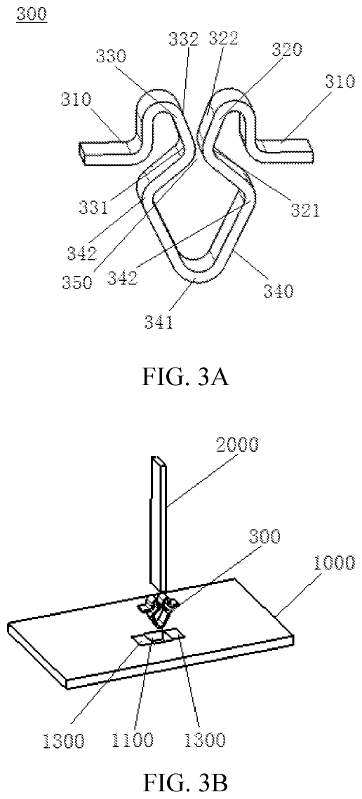

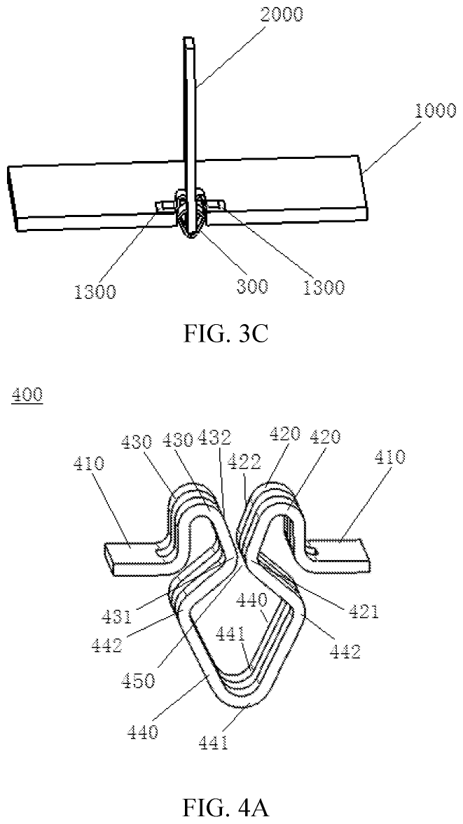

As shown in FIG. 3A, this embodiment provides an elastic connection structure 300, which includes: a pair of mount members 310, a first contact member 320, a second contact member 330, and a limit member 340, where the first contact member 320 and the second contact member 330 are in elastic connection to the corresponding mount member 310 respectively, and the limit member 340 is in elastic connection to a lower member of the first contact member 320 and a lower member of the second contact member 330.

In this embodiment, the first contact member 320 includes a first protrusion 321, and the second contact member 330 includes a second protrusion 331.

In this embodiment, the limit member 340 includes a first limit sub-member 341 and a second limit sub-member 342.

As shown in FIG. 3B and FIG. 3C, in this embodiment, the elastic connection structure 300 is in electrical connection first to the first circuit board 1000. In this embodiment, the first circuit board 1000 is provided with a mount hole 1100, such that a pair of mount members 310 are fixed on an outside of the mount hole 1100 of the first circuit board 1000, and the first contact member 320, the second contact member 330, and the limit member 340 are disposed inside of the mount hole 1100. In this embodiment, the first circuit board 1000 is provided with a connect part 1300 outside the mount hole 1100, such that the mount member 310 of the elastic connection structure 300 is fixed thereon. In this embodiment, the solder pad or weld pad designed on the first circuit board 1000 may be used as the connect part 1300.

Subsequently, the second circuit board 2000 is inserted into the elastic connection structure 300, such that the first contact member 320 of the elastic connection structure 300 becomes electrically connected to one side of the second circuit board 2000, and the second contact member 330 becomes electrically connected to another side of the second circuit board, and one end of the second circuit board 2000 is disposed inside of the limit member 340. In this embodiment, the first protrusion 321 of the first contact member 320 is electrically connected to one side of the second circuit board 2000, and the second protrusion 331 of the second contact member 330 is electrically connected to the other side of the second circuit board 2000, and one end of the second circuit board 2000 is disposed inside of the limit member 341 along a vertical direction. The second limit sub-member 342 contacts or pushes against the inner wall of the mount hole 1100 to limit the movement of the second circuit board 2000 in the horizontal direction.

When the first circuit board 1000 and the second circuit board 2000 are in electrical connection through the disclosed elastic connection structure 300, transmission of signals, voltages, currents, and the like may be realized between the first circuit board 1000 and the second circuit board 2000.

In addition, due to the existence of the first protrusion 321 in the first contact member 320, a slope or an inclined surface 322 is formed after the first contact member 320 is in elastic connection to the corresponding mount member 310; correspondingly, due to the existence of the second protrusion 331 in the second contact member 330, another slope 332 is formed after the second contact member 330 is in elastic connection to the corresponding mount member 310; thus, the two slopes form a V-shaped guide member 350, which guides the insertion of the second circuit board 2000 and allows presence of relatively larger tolerance at both sides of the second circuit board 2000 when the second circuit board 2000 is inserted into the elastic connection structure 300.

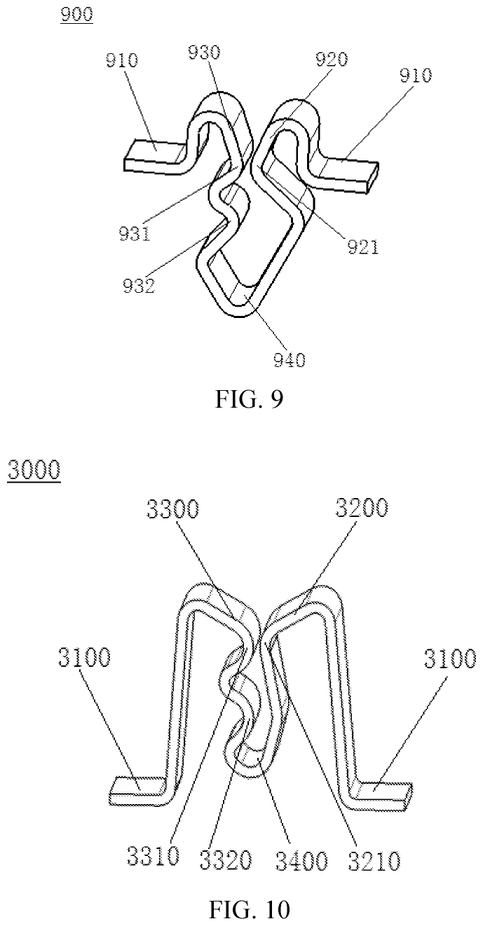

In this embodiment, another elastic connection structure 900 shown in FIG. 9 has an overall structure similar to the elastic connection structure 300 shown in FIGS. 3A-3C, for example, including a pair of mount members 910, a first contact member 920, a second contact member 930, and a limit member 940. In this embodiment, the first contact member 920 and the second contact member 930 are in elastic connection to the corresponding mount member 910 respectively, and the limit member 940 is in elastic connection to a lower member of the first contact member 920 and a lower member of the second contact member 930. In the elastic connection structure 900 shown in FIG. 9, the second contact member 930 includes a plurality of second protrusions (for example, second protrusions 931, second protrusions 932), such that the elastic connection structure 900 may realize a single-point electrical connection to the second circuit board on one side, and a multi-point electrical connection to the second circuit board on the other side, to meet desirables of different types of second circuit boards (for example, when different numbers of signal contacts are present on the two sides of the second circuit board).

### Embodiment Four

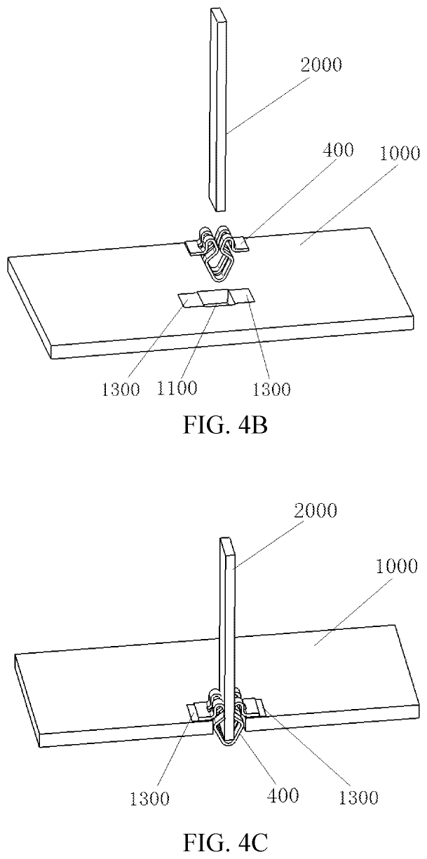

As shown in FIG. 4A, this embodiment provides an elastic connection structure 400, which includes: a pair of mount members 410, a plurality of first contact members 420, a plurality of second contact members 430, and a plurality of limit members 440. In this embodiment, each first contact member 420 and each second contact member 430 are in elastic connection to the corresponding mount member 410 respectively, each limit member 440 is in elastic connection to a lower member of the corresponding first contact member 420 and to a lower member of the corresponding second contact member 430.

In this embodiment, each first contact member 420 includes a first protrusion 421, and each second contact member 430 includes a second protrusion 431.

In this embodiment, each limit member 440 includes a first limit sub-member 441 and a second limit sub-member 442.

As shown in FIG. 4B and FIG. 4C, in this embodiment, the disclosed elastic connection structure 400 becomes first electrically connected to the first circuit board 1000. In this embodiment, the first circuit board 1000 is provided with a mount hole 1100, such that a pair of mount members 410 are fixed on the outside of the mount hole 1100 of the first circuit board 1000, and the first contact member 420, the second contact member 430, and the limit member 440 are disposed inside of the mount hole 1100. In this embodiment, the first circuit board 1000 is provided with a connect part 1300 on the outside of the mount hole 1100, such that the mount members 410 of the elastic connection structure 400 are fixed upon the connect part 1300. In this embodiment, the solder pad or weld pad designed on the first circuit board 1000 may be used as the connect member 1300.

In this embodiment, the second circuit board 2000 is inserted into the elastic connection structure 400, such that the plurality of first contact members 420 of the elastic connection structure 400 are electrically connected to one side of the second circuit board 2000, the plurality of second contact members 430 are electrically connected to another side of the second circuit board 2000, and one end of the second circuit board 2000 is disposed in the plurality of limit members 440. In this embodiment, the first protrusion 421 of each first contact member 420 is electrically connected to one side of the second circuit board 2000, and the second protrusion 431 of each second contact member 430 is electrically connected to the other side of the second circuit board 2000. In this embodiment, one end of the second circuit board 2000 is disposed inside of the plurality of first limit sub-members 441 along the vertical direction, and the plurality of second limit sub-members 442 contact or push against an inner wall of the mount hole 1100, to limit movement of the second circuit board 2000 along the horizontal direction.

When the first circuit board 1000 and the second circuit board 2000 are in electrical connection through the elastic connection structure 400, transmission of signals, voltages, currents, and the like may be realized between the first circuit board 1000 and the second circuit board 2000.

In this embodiment, due to the presence of the first protrusion 421 in the first contact member 420, each first contact member 420 is in elastic connection to the corresponding mount member 410 to form a slope 422; due to the presence of the second protrusion 431 in the second contact member 430, another slope 432 is formed after each second contact member 430 is elastically connected to the corresponding mount member 410; thus, the corresponding two slopes form a V-shaped guide member 450, which guides the insertion of the second circuit board 2000 and allows for a relatively larger tolerance at both sides of the second circuit board 2000.

### Embodiment Five

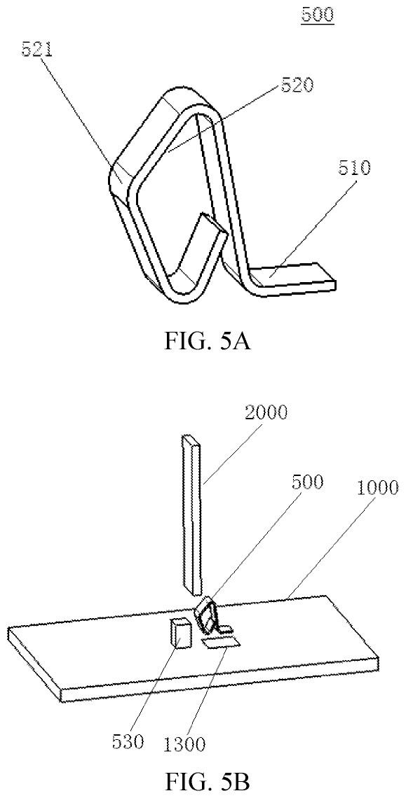

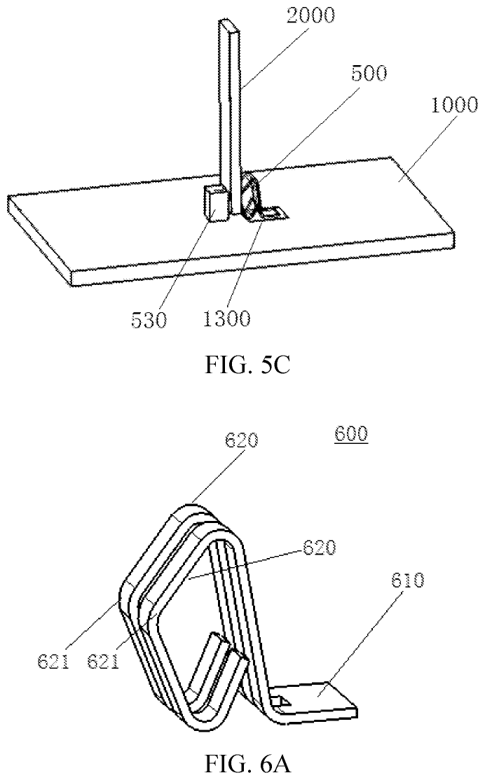

As shown in FIG. 5A, this embodiment provides an elastic connection structure 500, which includes: a mount member 510 and a contact member 520, where the contact member 520 is in elastic connection to the mount member 510.

In this embodiment, the contact member 520 includes a protrusion 521. As shown in FIG. 5A, and in this embodiment, the protrusion 521 is used for contact coupling with one side of the second circuit board 2000 shown in FIG. 5B and FIG. 5C.

In this embodiment, and as shown in FIG. 5C, the disclosed elastic connection structure 500 further includes a block member 530, which is used to limit the movement of the second circuit board 2000, and hence to keep the electrical connection between the second circuit board 2000 and the contact member 520.

In this embodiment, and as shown in FIG. 5B, the first circuit board 1000 is provided with a connect part 1300, and the mount member 510 of the elastic connection structure 500 is electrically connected to the connect part 1300, the block member 530 is disposed on the connect part 1300 opposite to the mount member 510, and the contact member 520 is disposed above the connect part 1300.

In this embodiment, the connect part 1300 may be in the form of a solder pad or a weld pad designed on the first circuit board 1000.

In this embodiment, and as shown in FIG. 5B and FIG. 5C, the mount member 510 is electrically connected to the first circuit board 1000 via the connect part 1300, such that the disclosed elastic connection structure 500 is electrically connected to the first circuit board 1000.

In this embodiment, the second circuit board 2000 is arranged in the elastic connection structure 500, such that the contact member 520 of the elastic connection structure 500 is electrically connected to one side of the second circuit board 2000, and the block member 530 is connected to another side of the second circuit board 2000. The contact electrical connection between the second circuit board 2000 and the contact member 520 is maintained by limiting the movement of the second circuit board 2000. In this embodiment, the first protrusion 521 of the contact member 520 is electrically connected to one side of the second circuit board 2000, and the block member 530 is electrically connected to the another side of the second circuit board 2000.

When the first circuit board 1000 and the second circuit board 2000 are in electrical connection through the elastic connection structure 500, transmission of signals, voltages, currents, and the like between the first circuit board 1000 and the second circuit board 2000 may be realized.

In this embodiment, and due to the design of the elastic connection structure 500, the second circuit board 2000 is electrically connected to one side of the elastic connection structure 500, thereby further reducing the occupied space of the elastic connection structure 500.

### Embodiment Six

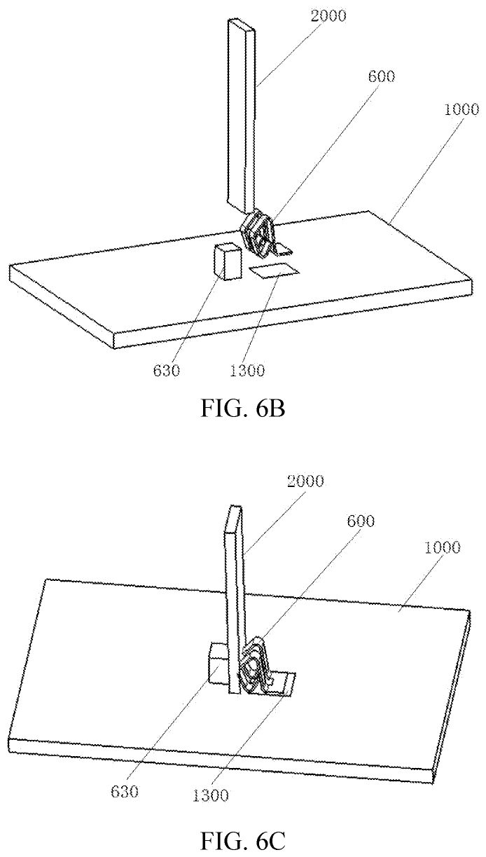

As shown in FIG. 6A, this embodiment provides an elastic connection structure 600, which includes: a mount member 610 and a plurality of contact members 620, where the plurality of contact members 620 are arranged at intervals along a thickness direction and in elastic connection to the mount member 610.

In this embodiment, each contact member 620 includes a protrusion 621. As shown in FIG. 6A, and in this embodiment, the protrusion 621 is used for contacting and coupling with one side of the second circuit board shown in FIG. 6B and FIG. 6C. To realize multi-point electrical connection between the elastic connection structure 600 and the second circuit board 2000 shown in FIG. 6B in a direction perpendicular to the vertical direction.

Further, in actual use, each contact member 620 may also include a plurality of protrusions 621 to realize multi-point electrical connection to the second circuit board 2000 in the vertical direction.

In this embodiment, and as shown in FIG. 6C, the disclosed elastic connection structure 600 further includes a block member 630, where, the block member 630 is used to limit the movement of the second circuit board 2000 to maintain the electrical connection between the second circuit board 2000 and the contact member 620.

In this embodiment, and as shown in FIG. 6B, the first circuit board 1000 is provided with a connect part 1300, and the mount member 610 of the elastic connection structure 600 is electrically connected to the connect part 1300. The block member 630 is disposed on the connect part 1300 opposite to the mount member 610, and the contact member 620 is disposed above the connect part 1300.

In this embodiment, a weld pad or a solder pad designed on the first circuit board 1000 may be used as the connect part 1300.

In this embodiment, and as shown in FIG. 6B and FIG. 6C, the mount member 610 is electrically connected to the first circuit board 1000 via the connect part 1300, such that the disclosed elastic connection structure 600 is electrically connected to the first circuit board 1000.

In this embodiment, the second circuit board 2000 is disposed in the elastic connection structure 600, such that the plurality of contact members 620 of the elastic connection structure 600 are electrically connected to one side of the second circuit board 2000, the block member 630 is in electrical contact to the other side of the second circuit board 2000 to limit the movement of the second circuit board 2000 to maintain the contact electrical connection between the second circuit board 2000 and the contact member 620. In this embodiment, the first protrusion 621 of the contact member 620 is electrically connected to one side of the second circuit board 2000, and the blocking member 630 is contact-coupled to the other side of the second circuit board 2000

When the first circuit board 1000 and the second circuit board 2000 are in electrical connection via the elastic connection structure 600, transmission of signals, voltages, currents, and the like may be realized between the first circuit board 1000 and the second circuit board 2000.

In this embodiment, due to the design of the elastic connection structure 600, the second circuit board 2000 is electrically connected to one side of the elastic connection structure 600 at multiple points, thereby further reducing the occupied space of the elastic connection structure 600.

### Embodiment Seven

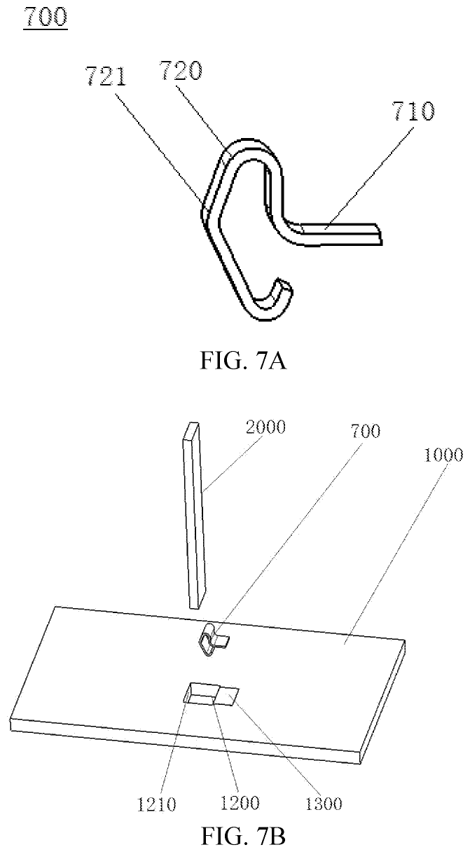

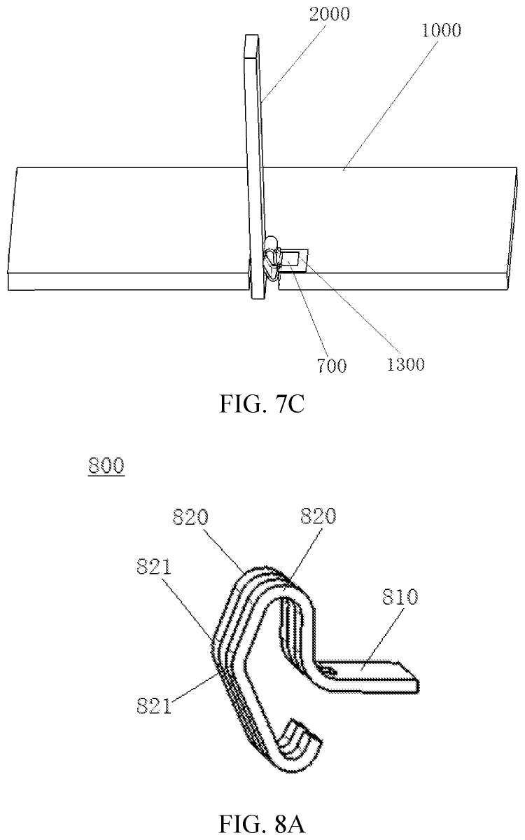

As shown in FIG. 7A, this embodiment provides an elastic connection structure 700, which includes: a mount member 710 and a contact member 720, where the contact member 720 is in elastic connection to the mount member 710.

In this embodiment, the contact member 720 includes a protrusion 721. As shown in FIG. 7A, the protrusion 721 is used for contact coupling with one side of the second circuit board 2000 shown in FIG. 7B and FIG. 7C, to realize an electrical connection between the elastic connection structure 700 and the second circuit board 2000.

In this embodiment, and as shown in FIG. 7B, the first circuit board 1000 is provided with a mount hole 1200, such that the mount member 710 of the elastic connection structure 700 is fixed outside the mount hole 1200, the contact member 720 is disposed in the mount hole 1200, and an inner wall 1210 of the mount hole 1200 works as a block member to maintain the contact electrical connection between the second circuit board 2000 and the contact member 720. In this embodiment, the first circuit board 1000 is provided with a connect part 1300 on the outside of the mount hole 1200, such that the mount member 710 of the elastic connection structure 700 is fixed upon the connect part 1300. In this embodiment, a weld pad or a solder pad designed on the first circuit board 1000 may be used as the connect part 1300.

In this embodiment, and as shown in FIG. 7B and FIG. 7C, the mount member 710 is electrically connected to the first circuit board 1000 through the mount hole 1200, such that the disclosed elastic connection structure 700 becomes electrically connected to the first circuit board 1000.

In this embodiment, the second circuit board 2000 is disposed in the elastic connection structure 700, such that the contact member 720 of the elastic connection structure 700 is electrically connected to one side of the second circuit board 2000, an inner wall 1210 limits the movement of the second circuit board 2000 in the vertical direction on the other side of the second circuit board 2000 to maintain the contact electrical connection between the second circuit board 2000 and the contact member 720. In this embodiment, the first protrusion 721 of the contact member 720 is electrically connected to one side of the second circuit board 2000, and the block member (for example, the inner wall 1200) is contact-coupled to the other side of the second circuit board 2000.

When the first circuit board 1000 and the second circuit board 2000 are in electrical connection via the elastic connection structure 700, transmission of signals, voltages, currents, and the like may be realized between the first circuit board 1000 and the second circuit board 2000.

In this embodiment, due to the design of the elastic connection structure 700, the second circuit board 2000 is electrically connected to one side of the elastic connection structure 700, thereby further reducing the occupied space of the elastic connection structure 700.

### Embodiment Eight

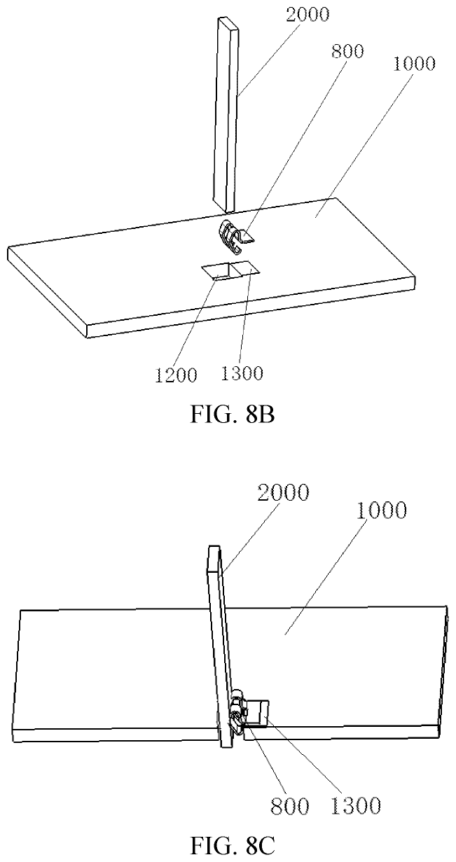

As shown in FIG. 8A, this embodiment provides an elastic connection structure 800, which includes: a mount member 810 and a plurality of contact members 820, where the plurality of contact members 820 are arranged at intervals and in elastic connection to the mount member 810.

In this embodiment, contact member 820 includes a protrusion 821. As shown in FIG. 8A, the protrusion 821 is used for contact coupling with one side of the second circuit board 2000 shown in FIG. 8B and FIG. 8C, to realize an electrical connection between the elastic connection structure 800 and the second circuit board 2000.

In this embodiment, and shown in FIG. 8B, the first circuit board 1000 is provided with a mount hole 1200, such that the mount member 810 of the elastic connection structure 800 is fixed outside of the mount hole. All the contact members 820 are disposed inside of the mount hole 1200, and the inner wall of the mount hole 1200 (similar to the inner wall 1210 in FIG. 7B, not shown here) acts as a block member, to keep the contact electrical connection between the second circuit board 2000 and all contact members. Moreover, the first circuit board 1000 is provided with a connect part 1300 positioned outside of the mount hole 1200, such that the mount member 810 of the elastic connecting structure 800 is fixed upon the connect part 1300. In certain embodiments, a weld pad or a solder pad designed on the first circuit board 1000 may be used as the connect part 1300.

In this embodiment, and as shown in FIG. 8B and FIG. 8C, the mount member 810 is electrically connected to the first circuit board 1000 through the mount hole 1200, such that the disclosed elastic connection structure 800 becomes electrically connected to the first circuit board 1000.

In this embodiment, the second circuit board 2000 is disposed in the elastic connection structure 800, such that the plurality of contact members 820 of the elastic connection structure 800 are electrically connected to one side of the second circuit board 2000, the inner wall of the mount member 1200 limits the movement of the second circuit board 2000 in the vertical direction on the other side of the second circuit board 2000, to maintain the contact electrical connection between the second circuit board 2000 and the plurality of contact members 820. In this embodiment, the first protrusion 821 of each contact member 820 is electrically connected to one side of the second circuit board 2000, and the block member (that is, the inner wall of the mount hole 1200) is contact-coupled with the other side of the second circuit board 2000.

When the first circuit board 1000 and the second circuit board 2000 are in electrical connection via the elastic connection structure 800, transmission of signals, voltages, currents, and the like may be realized between the first circuit board 1000 and the second circuit board 2000.

In this embodiment, due to the design of the elastic connection structure 800, the second circuit board 2000 is electrically connected to one side of the elastic connection structure 800 at multiple points, thereby further reducing the occupied space of the elastic connection structure 800.

In this embodiment, one or more combinations of the elastic connection structures described herein may be used.

The elastic connection structures described herein may be used in various implementation scenarios, for example, the spring connection structure may be used as a part of the antenna mounting and fixing structure on the roof of the car.

The elastic connection structures described herein may realize effective electrical connection between multiple circuit boards, make it easy to disassemble and assemble multiple circuit boards, and avoid a need to solder the circuit boards to realize the electrical connection between the circuit boards, thereby reducing pollution and reducing manufacturing costs.

A variety of elastic connection structures disclosed herein may be electrically connected to one side of one of the circuit boards through the elastic connection structure. It is also possible to realize electrical connection of multiple circuit boards by electrically connecting both sides of one of the circuit boards via the elastic connection structure. Electrical connection may be realized through single point connection to one side of one of the circuit boards via the elastic connection structure, and may also be realized through multiple-point connection to multiple circuit boards by connecting to one side of one of the circuit boards at multiple points via the elastic connection structure. Electrical connection may be realized to both sides of one of the circuit boards through the elastic connection structure, and may also be realized to two sides of one of the circuit boards at multiple points through the elastic connection structure to realize electrical connection to multiple circuit boards. Suitable elastic connection structure may be flexibly selected according to the design of different circuit boards to complete the electrical connection between the circuit boards.

The above descriptions are directed to certain embodiments of the present disclosure, and are not intended to limit the embodiments of the present disclosure. For those skilled in the art, various modifications and changes may be imparted onto certain embodiments of the present disclosure. Within the spirit and principles of certain embodiments of the present disclosure, any modifications, equivalents, replacements, improvements, and the like shall be included within the scope of protection of the present disclosure.

While certain embodiments of the present disclosure have been described herein, it is to be understood that the present disclosure are not limited to the embodiments disclosed. Embodiments of the present disclosure are intended to cover various modifications and equivalent arrangements included within the spirit and scope of the appended claims. The scope of the appended claims is accorded the broadest interpretation thereby encompassing all such modifications and equivalent structures and functions.

1. An elastic connection structure, comprising:
a pair of mount members, respectively electrically connected to a first circuit board;
at least one first contact member, configured to be in elastic connection to one of the pair of mount members and be electrically connected to one side of a second circuit board; and
at least one second contact member, configured to be in elastic connection to the other of the pair of mount members and be electrically connected to another side of the second circuit board,
wherein, the second circuit board is clamped between the first contact member and the second contact member, and the first circuit board is electrically connected to the second circuit board through the elastic connection structure.

2. The elastic connection structure according to claim 1, further comprising:
a limit member, configured to be in elastic connection to the first contact member and the second contact member, and to receive one end of the second circuit board.

3. The elastic connection structure according to claim 1, wherein the first contact member comprises:
one or more first protrusions, each of the first protrusions is configured to be in electrical connection to the one side of the second circuit board.

4. The elastic connection structure according to claim 3, wherein the second contact member comprises:
one or more second protrusions, each of the second protrusions is configured to be in electrical connection to the another side of the second circuit board.

5. The elastic connection structure according to claim 4, wherein a number of the first protrusions of the first contact member is same to or different than a number of the second protrusions of the second contact member.

6. The elastic connection structure according to claim 4, wherein the first protrusions and the second protrusions are of symmetrical or asymmetrical shape.

7. The elastic connection structure according to claim 2, wherein the limit member comprises:
a first limit sub-member, configured to limit movement of the second circuit board along a vertical direction.

8. The elastic connection structure according to claim 7, wherein the first circuit board is provided with a mount hole, and the pair of mount members are fixed outside of the mount hole, wherein the first contact member, the second contact member, and the limit member are arranged inside of the mount hole; wherein, the limit member further comprises a second limit sub-member, the second limit sub-member contacts an inner wall of the mount hole, and is configured to limit movement of the second circuit board along a horizontal direction.

9. The elastic connection structure according to claim 2, wherein the first circuit board includes a connect part, and the pair of mount members are fixed on the connect part, and the first contact member, the second contact member, and the limit member are arranged above the connect part.

10. The elastic connection structure according to claim 1, wherein, when the elastic connection structure includes a plurality of first contact members and a plurality of second contact members, the plurality of the first contact members are arranged at intervals and in elastic connection to one of the pair of mount members, and the plurality of second contact members are arranged at intervals and in elastic connection to another of the pair of mount members.

11. The elastic connection structure according to claim 4, wherein the first contact member is in elastic connection to the corresponding mount member to form a first slope, and the second contact member is in elastic connection to the corresponding mount member to form a second slope; the first slope and the corresponding second slope form a guide member.

12. An elastic connection structure, comprising:
a mount member, electrically connected to a first circuit board; and
at least one contact member, configured to be in elastic connection to the mount member and be electrically connected to one side of a second circuit board,
wherein the first circuit board is electrically connected to the second circuit board through the elastic connection structure.

13. The elastic connection structure according to claim 12, wherein the contact member comprises:
one or more protrusions, each of the protrusions is configured to be in electrical connection to the one side of the second circuit board.

14. The elastic connection structure according to claim 12, wherein the elastic connection structure further comprises:
a block member, configured to limit movement of the second circuit board, and hence to keep electrical connection between the second circuit board and the contact member.

15. The elastic connection structure according to claim 14, wherein the first circuit board is provided with a mount hole, and the mount member is fixed outside of the mount hole and the contact member is positioned inside of the mount hole, and wherein an inner wall of the mount hole is the block member to keep electrical connection between the second circuit board and the contact member.

16. The elastic connection structure according to claim 14, wherein the first circuit board includes a connect part, and the mount member is electrically connected to the connect part, the block member and the mount member are positioned on the connect part, and wherein the contact member is positioned above the connect part.

17. The elastic connection structure according to claim 12, wherein, when the elastic connection structure includes a plurality of contact members, the plurality of contact members are arranged at intervals and in elastic connection to the mount member.
